(19) United States
(12) Patent Application Publication
(10) Pub. No.: US 2014/0142241 A1
(43) Pub. Date: May 22, 2014

(54) PROPYLENE-BASED PLYMER WITH LOW ASH AND DEVICE WITH SAME

(71) Applicant: Chai-Jing Chou, Sugar Land, TX (US)

(72) Inventor: Chai-Jing Chou, Sugar Land, TX (US)

(21) Appl. No.: 14/122,732

(22) PCT Filed: Jul. 26, 2012
(86) PCT No.: PCT/US2012/048230

§ 371 Date: Nov. 27, 2013

Related U.S. Application Data
(60) Provisional application No. 61/512,592, filed on Jul. 28, 2011.

(51) Int. Cl. H01B 3/30; C08F 4/00

(52) U.S. Cl. CPC H01B 3/30; C08F 4/00
USPC 524/582; 526/213; 524/570

(57) ABSTRACT

The present disclosure provides a process for producing a wash-free propylene-based polymer with low total ash content for use as dielectric film. The propylene-based polymer contains a substituted phenylene aromatic diester and is suitable as a dielectric material for electrical devices.

### BACKGROUND

The present disclosure provides a propylene-based polymer with a low total ash content, a process for producing same, and a device containing same.

Catalyst residual negatively affects the properties of dielectric polymeric films. Conventional propylene-based polymer, for example, is typically washed prior to application as a dielectric material in order to remove catalyst residue and lower total ash content. Wash, however, is expensive, time consuming, and requires additional processing resources.

The art recognizes the need for propylene-based polymer with low total ash content for dielectric applications. Further desired is a propylene-based polymer with a low total ash content that does not require a wash procedure yet still exhibits acceptably low catalyst residual for use as a dielectric material.

### SUMMARY

The present disclosure provides a process. In an embodiment, a process for producing a propylene-based polymer is provided and includes contacting, under polymerization conditions, propylene and optionally one or more comonomers with a catalyst composition comprising a substituted phenylene aromatic diester. The process includes forming a wash-free propylene-based polymer with a total ash content less than 40 ppm, or less than 30 ppm.

In an embodiment, the process includes biaxially orienting the wash-free propylene-based polymer into a film having a thickness from 2 microns to 20 microns. The biaxially-oriented film has a total ash content less than 40 ppm, or less than 30 ppm.

The present disclosure provides a film and process for producing same. In an embodiment, the film includes a wash-free propylene-based polymer. The wash-free propylene-based polymer includes a substituted phenylene aromatic diester. The wash-free propylene-based polymer has a total ash content of less than 40 ppm, or less than 30 ppm.

In an embodiment, the film has less than 6.0 wt % xylene solubles content.

In an embodiment, the film has a thickness from 2 microns to 20 microns and a dielectric strength from 620 KV/mm to 720 KV/mm as measured in accordance with DIN IEC 243-2.

The present disclosure provides a device and process for producing same. In an embodiment, the device includes an electrical component and a propylene-based polymer in operative communication with the electrical component. The propylene-based polymer includes a substituted phenylene aromatic diester.

In an embodiment, the propylene-based polymer is a wash-free propylene-based polymer. In a further embodiment, the wash-free propylene-based polymer contains less than 40 ppm, or less than 30 ppm total ash content.

In an embodiment, the electrical component is selected from a transformer, a capacitor, a switch, a regulator, a circuit breaker, a recloser, a fluid-filled transmission line, and combinations thereof.

An advantage of the present disclosure is a wash-free process utilizing a catalyst containing a substituted phenylene aromatic diester for producing a wash-free propylene-based polymer with low total ash content.

An advantage of the present disclosure is a film made of a wash-free propylene-based polymer having a low total ash content, the film having advantageous dielectric properties, and high dielectric strength in particular.

An advantage of the present disclosure is the provision of a device with an electrical component and a dielectric film. The dielectric film is composed of a propylene-based polymer containing a substituted phenylene aromatic diester. The dielectric film is composed of a wash-free propylene-based polymer having a total ash content of less than 40 ppm, or less than 30 ppm.

### DETAILED DESCRIPTION

1. Process

The present disclosure provides a process for producing an olefin-based copolymer with low total ash content. The term “olefin-based polymer” is a polymer containing, in polymerized form, a majority weight percent of an olefin based on the total weight of the polymer. Nonlimiting examples of olefin-based polymers include ethylene-based polymers and propylene-based polymers.

In an embodiment the olefin-based polymer is a propylene-based polymer. The process includes contacting, under polymerization conditions, propylene and optionally one or more comonomers with a catalyst composition. The catalyst composition includes a substituted phenylene aromatic diester. The process further includes forming a wash-free propylene-based polymer with a total ash content less than 40 ppm, or less than 30 ppm.

As used herein, “polymerization conditions” are temperature and pressure parameters within a polymerization reactor suitable for promoting polymerization between the catalyst composition and an olefin to form the desired polymer. The polymerization process may be a gas phase, a slurry, or a bulk polymerization process, operating in one, or more than one, reactor. In an embodiment, the olefin is propylene and optionally ethylene.

As used herein, “a catalyst composition” is a composition that forms an olefin-based polymer when contacted with an olefin under polymerization conditions. The catalyst composition includes a procatalyst composition and a cocatalyst. The catalyst composition may optionally include an external electron donor and/or an activity limiting agent.

The procatalyst composition includes a combination of a magnesium moiety, a titanium moiety and an internal electron donor. The internal electron donor includes the substituted phenylene aromatic diester. The procatalyst composition is produced by way of a halogenation procedure which converts a procatalyst precursor and the substituted phenylene aromatic diester donor into the combination of the magnesium and titanium moieties, into which the internal electron donor is incorporated. The procatalyst precursor from which the procatalyst composition is formed can be a magnesium moiety precursor, a mixed magnesium/titanium precursor, or a benzoate-containing magnesium chloride precursor.

In an embodiment, the magnesium moiety is a magnesium halide. In another embodiment, the magnesium halide is magnesium chloride, or magnesium chloride alcohol adduct.

In an embodiment, the titanium moiety is a titanium halide such as a titanium chloride. In another embodiment the titanium moiety is titanium tetrachloride.

In an embodiment, the procatalyst composition includes a magnesium chloride support upon which a titanium chloride is deposited and into which the internal electron donor is incorporated.

The internal electron donor of the procatalyst composition includes a substituted phenylene aromatic diester. The term “substituted phenylene aromatic diester,” (or “SPAD”) as used herein, may be a substituted 1,2-phenylene aromatic diester, a substituted 1,3 phenylene aromatic diester, or a substituted 1,4 phenylene aromatic diester.

In an embodiment, the substituted phenylene aromatic diester is a 1,2-phenylene aromatic diester with the structure (I) below:

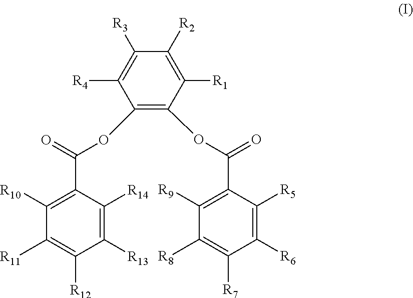

wherein R₁-R₁₄ are the same or different. Each of R₁-R₁₄ is selected from a hydrogen, substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. At least one of R₁-R₁₄ is not hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In an embodiment, at least one (or two, or three, or four) R group(s) of R₁-R₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In an embodiment, the SPAD is 3-methyl-5-tert-butyl-1,2-phenylene dibenzoate. Further nonlimiting examples of suitable SPAD are provided in Table 2 in the Examples section.

The catalyst composition includes a cocatalyst. As used herein, a “cocatalyst” is a substance capable of converting the procatalyst to an active polymerization catalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is a hydrocarbyl aluminum compound represented by the formula RₙAlX₃₋ₙ wherein n=1 or 2, R is an alkyl, and X is a halide or alkoxide. Nonlimiting examples of suitable compounds are as follows: methylaluminoxane, isobutylaluminoxane, diethylaluminum ethoxide, diisobutylaluminum chloride, tetraethyldialuminoxane, tetraisobutyldialuminoxane, diethylaluminum chloride, ethylaluminum dichloride, methylaluminum dichloride, and dimethylaluminum chloride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

In an embodiment, the catalyst composition includes an external electron donor. As used herein, an “external electron donor” is a compound added independent of procatalyst formation and contains at least one functional group that is capable of donating a pair of electrons to a metal atom. Bounded by no particular theory, it is believed that the external electron donor enhances catalyst stereoselectivity, (i.e., to reduce xylene soluble material in the formant polymer).

In an embodiment, the external electron donor may be selected from one or more of the following: an alkoxysilane, an amine, an ether, a carboxylate, a ketone, an amide, a carbamate, a phosphine, a phosphate, a phosphite, a sulfonate, a sulfone, and/or a sulfoxide.

In an embodiment, the external electron donor is an alkoxysilane. The alkoxysilane has the general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. Nonlimiting examples of suitable silane compositions include dicyclopentyldimethoxysilane, di-tert-butyldimethoxysilane, methylcyclohexyldimethoxysilane, methylcyclohexyldiethoxysilane, ethylcyclohexyldimethoxysilane, diphenyldimethoxysilane, diisopropyldimethoxysilane, di-n-propyldimethoxysilane, diisobutyldimethoxysilane, diisobutyldiethoxysilane, isobutylisopropyldimethoxysilane, di-n-butyldimethoxysilane, cyclopentyltrimethoxysilane, isopropyltrimethoxysilane, n-propyltrimethoxysilane, n-propyltriethoxysilane, ethyltriethoxysilane, tetramethoxysilane, tetraethoxysilane, diethylaminotriethoxysilane, cyclopentylpyrrolidinodimethoxysilane, bis(pyrrolidino)dimethoxysilane, bis(perhydroisoquinolino)dimethoxysilane, and dimethyldimethoxysilane. In an embodiment, the silane composition is dicyclopentyldimethoxysilane (DCPDMS), methylcyclohexyldimethoxysilane (MChDMS), or n-propyltrimethoxysilane (NPTMS), and any combination of thereof.

In one embodiment, the external electron donor is dicyclopentyldimethoxysilane. In another embodiment, the external electron donor is n-propyltrimethoxysilane.

In an embodiment, the external donor can be a mixture of at least two alkoxysilanes. In a further embodiment, the mixture can be dicyclopentyldimethoxysilane and methylcyclohexyldimethoxysilane, dicyclopentyldimethoxysilane and tetraethoxysilane, or dicyclopentyldimethoxysilane and n-propyltriethoxysilane.

In an embodiment, the external electron donor is selected from one or more of the following: a benzoate, a succinate, and/or a diol ester. In an embodiment, the external electron donor is 2,2,6,6-tetramethylpiperidine. In another embodiment, the external electron donor is a diether.

In an embodiment, the catalyst composition includes an activity limiting agent (ALA). As used herein, an “activity limiting agent” (“ALA”) is a material that reduces catalyst activity at elevated temperature (i.e., temperature greater than about 85° C.). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester, a diether, a poly(alkene glycol), a diol ester, and combinations thereof. The carboxylic acid ester can be an aliphatic or aromatic, mono- or poly-carboxylic acid ester. Nonlimiting examples of suitable monocarboxylic acid esters include ethyl and methyl benzoate, ethyl p-methoxybenzoate, methyl p-ethoxybenzoate, ethyl p-ethoxybenzoate, ethyl acrylate, methyl methacrylate, ethyl acetate, ethyl p-chlorobenzoate, hexyl p-aminobenzoate, isopropyl naphthenate, n-amyl toluate, ethyl cyclohexanoate and propyl pivalate.

Nonlimiting examples of suitable polycarboxylic acid esters include dimethyl phthalate, diethyl phthalate, di-n-propyl phthalate, diisopropyl phthalate, di-n-butyl phthalate, diisobutyl phthalate, di-tert-butyl phthalate, diisoamyl phthalate, di-tert-amyl phthalate, dineopentyl phthalate, di-2-ethylhexyl phthalate, di-2-ethyldecyl phthalate, diethyl terephthalate, dioctyl terephthalate, and bis[4-(vinyloxy)butyl]terephthalate.

The aliphatic carboxylic acid ester may be a C₄-C₃₀ aliphatic acid ester, may be a mono- or a poly- (two or more) ester, may be straight chain or branched, may be saturated or unsaturated, and any combination thereof. The C₄-C₃₀ aliphatic acid ester may also be substituted with one or more Group 14, 15 or 16 heteroatom containing substituents. Nonlimiting examples of suitable C₄-C₃₀ aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a myristate, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate or di-n-butyl sebacate.

The present process forms a wash-free propylene-based polymer with a total ash content less than 40 ppm, or less than 30 ppm. The term “wash-free,” or “wash-free propylene-based polymer,” as used herein, is a polymer whereby no wash agent is applied and/or no wash column is utilized to remove catalyst residuals from the formant propylene-based polymer. Upon completion of polymerization (i.e., post-quench), conventional propylene-based polymer is typically washed with a wash agent, such as a hydrocarbon, an alcohol, or carbon tetrachloride (and/or passed through a wash column) to remove catalyst residual from the polymer. In contrast, the present wash-free propylene-based polymer is not subjected to (i) a wash procedure, (ii) a wash agent, or (iii) a wash column after polymerization. The present process forms a wash-free propylene-based polymer with a total ash content less than 40 ppm, or less than 30 ppm, or 0 ppm, or from greater than 0 ppm, or 2 ppm, or 5 ppm to less than 30 ppm, or 25 ppm, or 20, ppm, or 15 ppm, or 10 ppm total ash content. The term “total ash content” is the aggregate amount of Al, Ti, Mg and Cl in parts per million (ppm) present in the formant propylene-based polymer.

Applicant has discovered that a catalyst composition with substituted phenylene aromatic diester (SPAD) as internal electron donor unexpectedly decreases the total ash content in the final polymer product when compared to conventional catalyst systems. The reduction in total ash content by way of the present SPAD-containing catalyst composition is so dramatic that a wash step is unnecessary. Bounded by no particular theory, it is believed that the presence of the SPAD in the catalyst composition increases the catalyst activity. The increase in catalyst activity requires less catalyst composition to polymerize propylene (and optional comonomer) and form the propylene-based polymer. With less starting catalyst required, catalyst residual in the formant polymer is markedly decreased. The reduction in the amount of catalyst composition reduces the amount of catalyst residual in the formant propylene-based polymer, thereby reducing the total ash content in the polymer. In this way, provision of the SPAD in the catalyst composition avoids or otherwise eliminates the need for washing the formant propylene-based polymer, thereby yielding the “wash-free propylene-based polymer.”

The present wash-free propylene-based polymer eliminates the post-reactor wash step performed with conventional propylene-based polymer. Accordingly, the present wash-free propylene-based polymer advantageously requires less energy to produce, is more cost effective, and exhibits greater production efficiencies than conventional propylene-based polymer subject to a wash step.

In an embodiment, the process includes forming a wash-free propylene-based polymer with from 0 ppm, or greater than 0 ppm, or 2 ppm, or 5 ppm to 10 ppm, or 8 ppm aluminum.

In an embodiment, the process includes forming a wash-free propylene-based polymer with from 0 ppm, or greater than 0 ppm, or 2 ppm, or 5 ppm to 10 ppm, or 8 ppm chlorine.

In an embodiment, the process includes forming a wash-free propylene-based polymer with from 0 ppm, or greater than 0 ppm, or 2 ppm, or 5 ppm to 10 ppm, or 8 ppm magnesium.

In an embodiment, the process includes forming a wash-free propylene-based polymer with from 0 ppm, or greater than 0 ppm, or 2 ppm, or 5 ppm to 10 ppm, or 8 ppm titantium.

It is understood that the aggregate amount of aluminum, chlorine, magnesium and titanium is less than 40 ppm, or less than 30 ppm.

The SPAD-containing propylene-based polymer may be washed. When washed, the SPAD-containing propylene-based exhibits exceptionally low, or no, total ash content. In an embodiment, the process includes washing the SPAD-containing propylene-based polymer and forming a propylene-based polymer with less than 10 ppm, or from 0 ppm, or greater than 0 ppm, or 2 ppm, or 3 ppm, or 4 ppm, to less than 10 ppm, or 8 ppm, or 5 ppm total ash content.

In an embodiment, the process includes forming a wash-free propylene-based polymer with a xylene solubles content from 2.0 wt %, or 2.5 wt %, or 3.0 wt % to 6.0 wt %, or less than 6.0 wt %, or 5.5 wt %, or 5.0 wt %, or 4.5 wt % or 4.0 wt %.

In an embodiment, the process includes forming a wash-free propylene-based polymer with a melt flow rate from 0.5 g/10 min, or 1.0 g/10 min, or 1.5 g/10 min, or 2.0 g/10 min, or 2.5 g/10 min to 4.0 g/10 min, or 3.5 g/10 min, or 3.0 g/10 min.

In an embodiment, the process includes contacting, under polymerization conditions, the SPAD-containing catalyst with propylene monomer and forming a wash-free propylene homopolymer.

In an embodiment, the process includes contacting, under polymerization conditions, propylene and ethylene with the catalyst composition containing the SPAD and forming a wash-free propylene/ethylene copolymer with a total ash content less than 40 ppm, or less than 30 ppm. The propylene/ethylene copolymer has a total ash content and/or a catalyst residual content as described above for the propylene-based polymer.

In an embodiment, the wash-free propylene/ethylene copolymer has an ethylene content from 0.1 wt %, or 0.5 wt % to 1.0 wt %.

In an embodiment, the process includes biaxially orienting the propylene-based polymer, and forming a film having a thickness from 2 microns, or 4 microns to 20 microns, or 10 microns, or 8 microns, or 6 microns. The biaxially oriented film has a total ash content from 0 ppm, or greater than 0 ppm, or 2 ppm, or 5 ppm to less than 40 ppm, or less than 30 ppm, or less than 20 ppm, or less than 15 ppm, or less than 10 ppm.

The present propylene-based polymer may comprise two or more embodiments disclosed herein.

2. Film

The present process includes forming a film with the wash-free propylene-based polymer. In an embodiment, the film includes the present wash-free propylene-based polymer containing the substituted phenylene aromatic diester and less than 40 ppm, or less than 30 ppm total ash content. The film has a thickness from 2 microns, or 4 microns to 20 microns, or 10 microns, or 8 microns, or 6 microns. The film has a total ash content less than 40 ppm, or less than 30 ppm. In an embodiment, the film has a total ash content from 0 ppm, or from greater than 0 ppm, or 2 ppm, or 5 ppm to less than 30 ppm, or 25 ppm, or 20, ppm, or 15 ppm, or 10 ppm.

The term “film” is a sheet, a layer, a web, or the like or combinations thereof, having length and breadth dimensions and having two major surfaces with a thickness therebetween. A film can be a monolayer film (having only one layer) or a multilayer film (having two or more layers). In an embodiment, the film is a monolayer film with a thickness from 2 microns to 20 microns.

The film forming process may include one or more of the following procedures: extrusion, coextrusion, cast extrusion, blown film formation, double bubble film formation, tenter frame techniques, calendaring, coating, dip coating, spray coating, lamination, biaxial orientation, injection molding, thermoforming, compression molding, and any combination of the foregoing.

In an embodiment, the process includes forming a multilayer film. The term “multilayer film” is a film having two or more layers. Layers of a multilayer film are bonded together by one or more of the following nonlimiting processes: coextrusion, extrusion coating, vapor deposition coating, solvent coating, emulsion coating, or suspension coating.

In an embodiment, the process includes forming an extruded film. The term “extrusion,” and like terms, is a process for forming continuous shapes by forcing a molten plastic material through a die, optionally followed by cooling or chemical hardening. Immediately prior to extrusion through the die, the relatively high-viscosity polymeric material is fed into a rotating screw, which forces it through the die. The extruder can be a single screw extruder, a multiple screw extruder, a disk extruder or a ram extruder. The die can be a film die, blown film die, sheet die, pipe die, tubing die or profile extrusion die. Nonlimiting examples of extruded articles include pipe, film, and/or fibers.

In an embodiment, the process includes forming a coextruded film. The term “coextrusion,” and like terms, is a process for extruding two or more materials through a single die with two or more orifices arranged so that the extrudates merge or otherwise weld together into a laminar structure. At least one of the coextruded layers contains the present wash-free propylene-based polymer. Coextrusion may be employed as an aspect of other processes, for instance, in film blowing, casting film, and extrusion coating processes.

In an embodiment, the process includes forming a blown film. The term “blown film,” and like terms, is a film made by a process in which a polymer or copolymer is extruded to form a bubble filled with air or another gas in order to stretch the polymeric film. Then, the bubble is collapsed and collected in flat film form.

In an embodiment, the film has a thickness less than 4 microns and the total ash content is less than 15 ppm or from greater than 0 ppm, or 2 ppm, or 5 ppm to less than 15 ppm, or 10 ppm, or 8 ppm.

In an embodiment, the process includes forming a biaxially oriented film. A “biaxially oriented film” is a film stretched in both longitudinal and transverse directions. The biaxially oriented film has a thickness from 2 microns, or 4 microns to 20 microns, or 10 microns, or 8 microns, or 6 microns. The biaxially oriented film has a total ash content less than 40 ppm, or less than 30 ppm, or from greater than 0 ppm, or 2 ppm, or 5 ppm to less than 30 ppm, or 25 ppm, or 20, ppm, or 15 ppm, or 10 ppm, or 8 ppm.

In an embodiment, the film is biaxially oriented, has a thickness of 2 microns to 20 microns and a dielectric strength from 620 KV/mm to 720 KV/mm.

The present film may comprise two or more embodiments disclosed herein.

3. Device

The present disclosure provides a device and a process for producing the device. The device includes an electrical component and a propylene-based polymer in operative communication with the electrical component. The propylene-based polymer includes the substituted phenylene aromatic diester. In an embodiment, the propylene-based polymer has a total ash content less than 30 ppm as disclosed above.

Nonlimiting examples of suitable electrical components include a transformer, a capacitor, a switching gear, a transmission component, a distribution component, a switch, a regulator, a circuit breaker, an autorecloser, or like components, a fluid-filled transmission line, and/or combinations thereof.

In an embodiment, the present process includes placing the wash-free propylene-based polymer in operative communication with the electrical component. As used herein, “operative communication” is a configuration and/or a spatial relationship enabling the propylene-based polymer to contact the electrical component. Operative communication thereby includes direct contact and/or indirect contact between the wash-free propylene-based polymer and the electrical component by way of the following configurations: the wash-free propylene-based polymer, in, on, around, adjacent to, contacting, surrounding (wholly or partially) through, and/or in proximity to the electrical component.

In an embodiment, operative communication between the wash-free propylene-based polymer and the electrical component is obtained by coating the electrical component with the wash-free propylene-based polymer. The electrical component may be wholly coated (entirely encased) or partially coated (partially covered) with the wash-free propylene-based polymer.

The wash-free propylene-based polymer is any propylene-based polymer as previously disclosed herein. The wash-free propylene-based polymer contains a substituted phenylene aromatic diester. In a further embodiment, the substituted phenylene aromatic diester is 3-methyl-5-tert-butyl-1,2-phenylene dibenzoate.

In an embodiment, the wash-free propylene-based polymer coated onto the electrical component has less than 30 ppm total ash content.

In an embodiment, the device is a metalized polypropylene film capacitor wherein the present wash-free propylene-based polymer is applied as a film on the capacitor.

In an embodiment, the process includes forming a film on the electrical component. The film is in operative communication with the electrical component. The film can be any of the foregoing films containing the wash-free propylene-based polymer, SPAD, and less than 40 ppm, or less than 30 ppm total ash content.

Nonlimiting configurations for operative communication between the film and the electrical component include: (1) the film may be one or more dielectric layer(s) in the electrical component (such as in a capacitor); or (2) the film may be a coating on the electrical component.

In an embodiment, the process includes forming a film on an electrical component that is a capacitor, the film composed of the wash-free propylene-based polymer such that the film is in operative communication with the capacitor. The film has a thickness from 2 microns to 20 microns and a total ash content less than 40 ppm, or less than 30 ppm. In other words, the film is applied as one or more dielectric layer(s) of the capacitor and is a component of the capacitor.

In an embodiment, the device includes (i) the electrical component, (ii) the wash-free propylene-based polymer in the form of a film, and (iii) a dielectric fluid. A “dielectric fluid” is a non-conducting fluid having a dielectric breakdown greater than 20 kV as measured in accordance with ASTM D 1816 (VDE electrodes, 1 mm gap) and/or a dissipation factor of less than 0.2% as measured in accordance with ASTM D 924 (60 Hz, 25° C.), and less than 4 at 100° C. (ASTM D 924, 60 Hz). A dielectric fluid provides coolant and/or insulative properties when placed in operative communication with the electrical component.

In an embodiment, the film contacts the dielectric fluid. Accordingly, nonlimiting configurations for operative communication between the film and the electrical component include: the film may be one or more dielectric layer(s), or barrier layer(s) for a fluid-filled or a fluid-impregnated electrical device (such as a capacitor or a transformer).

In an embodiment, the dielectric fluid may be a vegetable oil (corn, soybean), a seed oil (castor, sunflower, rape seed), an algae oil, a microbial oil (optionally genetically engineered), and combinations thereof.

In an embodiment, the dielectric fluid is a halogen-free dielectric fluid. The halogen-free dielectric fluid is in contact with the SPAD-containing film.

The present device may comprise two or more embodiments disclosed herein.

### DEFINITIONS

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the percent compositions.

“Composition”, “formulation” and like terms are a mixture or blend of two or more components. In the context of a mix or blend of materials from which a cable sheath or other article of manufacture is fabricated, the composition includes all the components of the mix, e.g., polypropylene, polyethylene co-polymer, metal hydrate and any other additives such as cure catalysts, antioxidants, flame retardants, etc.

“Comprising”, “including”, “having” and like terms are not intended to exclude the presence of any additional component, step or procedure, whether or not the same is specifically disclosed. In order to avoid any doubt, all processes claimed through use of the term “comprising” may include one or more additional steps, pieces of equipment or component parts, and/or materials unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

The term, “ethylene-based polymer,” as used herein, is an interpolymer that comprises a majority weight percent polymerized ethylene monomer (based on the total amount of polymerizable monomers), and optionally may comprise at least one polymerized comonomer.

“Interpolymer” is a polymer prepared by the polymerization of at least two different types of monomers. This generic term includes copolymers, which are polymers prepared from two different types of monomers, and polymers prepared from more than two different types of monomers, e.g., terpolymers, tetrapolymers, etc.

“Polymer” is a polymeric compound prepared by polymerizing monomers, whether of the same or a different type. The generic term polymer thus embraces the term homopolymer, which is a polymer prepared from only one type of monomer, and the term interpolymer as defined below.

“Polyolefin”, “PO” and like terms are a polymer derived from simple olefins. Many polyolefins are thermoplastic and for purposes of this disclosure, can include a rubber phase. Representative polyolefins include polyethylene, polypropylene, polybutene, polyisoprene and their various interpolymers.

The term, “propylene-based polymer,” as used herein, is an interpolymer that comprises a majority weight percent polymerized propylene monomer (based on the total amount of polymerizable monomers), and optionally may comprise at least one polymerized comonomer.

The term, “propylene/ethylene copolymer,” as used herein, is an interpolymer that comprises a majority weight percent polymerized propylene monomer (based on total amount of polymerizable monomers), and comprises polymerized ethylene.

### Test Methods

¹³C NMR characterization (ethylene content, Koenig B-value, triad distribution, triad tacticity, number average sequence length for ethylene and propylene (i.e., le and lp respectively) is performed as follows:

### Sample Preparation

The samples are prepared by adding approximately 2.7 g of a 50/50 mixture of tetrachloroethane-d₂/orthodichlorobenzene containing 0.025 M Cr(AcAc)₃ to 0.20 g sample in a Norell 1001-7 10 mm NMR tube. The samples are dissolved and homogenized by heating the tube and its contents to 150° C. using a heating block and heat gun. Each sample is visually inspected to ensure homogeneity.

### Data Acquisition Parameters

The data are collected using a Bruker 400 MHz spectrometer equipped with a Bruker Dual DUL high-temperature CryoProbe. The data are acquired using 1280 transients per data file, a 6 sec pulse repetition delay, 90 degree flip angles, and inverse gated decoupling with a sample temperature of 120° C. All measurements are made on non-spinning samples in locked mode. Samples are allowed to thermally equilibrate for 7 minutes prior to data acquisition

Dielectric strength is a measure of the electrical field strength an insulating material can withstand without experiencing a failure of its insulating properties. Dielectric strength is measured in accordance with DIN IEC 243-2

Gel Permeation Chromatography (GPC) Analytical Method for Polypropylene. The polymers are analyzed on a PL-220 series high temperature gel permeation chromatography (GPC) unit equipped with a refractometer detector and four PLgel MixeD A (20 μm) columns (Polymer Laboratory Inc.). The oven temperature is set at 150° C. and the temperatures of autosampler's hot and the warm zones are at 135° C. and 130° C. respectively. The solvent is nitrogen purged 1,2,4-trichlorobenzene (TCB) containing ˜200 ppm 2,6-di-t-butyl-4-methylphenol (BHT). The flow rate is 1.0 mL/min and the injection volume was 200 μl. A 2 mg/mL sample concentration is prepared by dissolving the sample in N₂ purged and preheated TCB (containing 200 ppm BHT) for 2.5 hrs at 160° C. with gentle agitation.

The GPC column set is calibrated by running twenty narrow molecular weight distribution polystyrene standards. The molecular weight (MW) of the standards ranges from 580 to 8,400,000 g/mol, and the standards were contained in 6 “cocktail” mixtures. Each standard mixture has at least a decade of separation between individual molecular weights. The polystyrene standards are prepared at 0.005 g in 20 mL of solvent for molecular weights equal to or greater than 1,000,000 g/mol and 0.001 g in 20 mL of solvent for molecular weights less than 1,000,000 g/mol. The polystyrene standards are dissolved at 150° C. for 30 min under stirring. The narrow standards mixtures are run first and in order of decreasing highest molecular weight component to minimize degradation effect. A logarithmic molecular weight calibration is generated using a forth-order polynomial fit as a function of elution volume. The equivalent polypropylene molecular weights are calculated by using following equation with reported Mark-Houwink coefficients for polypropylene (Th. G. Scholte, N. L. J. Meijerink, H. M. Schoffeleers, and A. M. G. Brands, J. Appl. Polym. Sci., 29, 3763-3782 (1984)) and polystyrene (E. P. Otocka, R. J. Roe, N.Y. Hellman, P. M. Muglia, Macromolecules, 4, 507 (1971)):

$${M}_{PP} = {( \frac{{K}_{PS} {M}_{PS}^{{a}_{PS} + 1}}{{K}_{PP}} )}^{\frac{1}{{a}_{PP} + 1}}$$

where Mₚₚ is PP equivalent MW, M_{PS} is PS equivalent MW, log K and a values of Mark-Houwink coefficients for PP and PS are listed below in Table 1.

TABLE 1

| Polymer | A | log K |
|---|---|---|
| Polypropylene | 0.725 | −3.721 |
| Polystyrene | 0.702 | −3.900 |

Isotaticity is measured using a Bruker 400 MHz spectrometer equipped with a Bruker Dual DUL high-temperature CryoProbe. The data is acquired using 320 transients per data file, a 6 sec pulse repetition delay (4.7 s delay+1.3 s acq. time), 90 degree flip angles, and inverse gated decoupling with a sample temperature of 120° C. All measurements are made on non-spinning samples in locked mode. Samples are homogenized immediately prior to insertion into the heated (125° C.) NMR Sample changer, and are allowed to thermally equilibrate in the probe for 7 minutes prior to data acquisition. The ¹³C NMR chemical shifts are internally referenced to the mmmm isotactic pentad at 21.90 ppm.

Izod impact strength is measured in accordance with ASTM D 256.

Liso (isotactic block length) is defined by the following equation:

(2*mmmm/mmrr)+3.

Melt flow rate (MFR) is measured in accordance with ASTM D 1238 test method at 230° C. with a 2.16 kg weight for propylene-based polymers.

Molecular weights (Mn, Mw and Mz) and MWD's (Mw/Mn and Mz/Mw) are measured by GPC. Polystyrene standards are used for calibration.

Oligomer content is measured by extracting 0.5 g of polymer with 5 g of chloroform for 12 hours at room temperature. The extract is injected into an Agilent 6890 Gas Chromatographer with a flame ionization detector (Agilent Technologies, Inc., Wilmington, Del.). The column is a 30 m×0.25 mm i.d. fused silica capillary; 0.25 μM film thickness of methyl silicon (DB-1). The oven is operated at an initial temperature of 50° C. for 4 minutes, program to 340° C. at 10° C./minute and held for 30 minutes. The oligomer quantification was done by comparing to an internal hexadecane standard.

Polydispersity Index (PDI) is measured using a Rheometrics 800 cone and plate rheometer from TA Instruments, operated at 180° C., using the method of Ziechner and Patel, (1981) “A Comprehensive Study of Polypropylene Melt Rheology” Proc. of the 2^{nd} World Congress of Chemical Eng., Montreal, Canada. In this method the cross-over modulus is determined, and the PDI defined as 100,000/cross-over modulus (in Pascals).

Total Ash Content and elemental residual content is determined by x-ray fluorescence spectroscopy in accordance with ASTM D 6247.

Xylene Solubles (XS) is measured according to the following procedure: 0.4 g of polymer is dissolved in 20 ml of xylenes with stirring at 130° C. for 30 minutes. The solution is then cooled to 25° C. and after 30 minutes the insoluble polymer fraction is filtered off. The resulting filtrate is analyzed by Flow Injection Polymer Analysis using a Viscotek ViscoGEL H-100-3078 column with THF mobile phase flowing at 1.0 ml/min. The column is coupled to a Viscotek Model 302 Triple Detector Array, with light scattering, viscometer and refractometer detectors operating at 45° C. Instrument calibration was maintained with Viscotek PolyCAL™ polystyrene standards.

Some embodiments of the present disclosure will now be described in detail in the following Examples.

### EXAMPLES

### 1. Substituted Phenylene Aromatic Diester

Nonlimiting examples of suitable substituted phenylene aromatic diester are provided in Table 2 below.

TABLE 2

| | | ¹H NMR (500 MHz, CDCl₃, |
|---|---|---|
| Compound | Structure | ppm) |
| 1,2-phenylene dibenzoate (IED1)* | 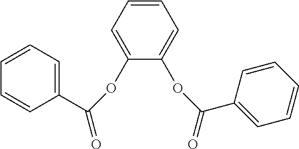 [SMILES: O=C(Oc1ccccc1OC(=O)c1ccccc1)c1ccccc1] | δ 8.08 (dd, 4H), 7.54 (tt, 2H), 7.34-7.43 (m, 8H). |
| 3-methyl-5-tert-butyl-1,2-phenylene dibenzoate (IED2) | 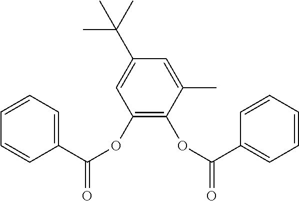 [SMILES: Cc1cc(C(C)(C)C)cc(OC(=O)c2ccccc2)c1OC(=O)c1ccccc1] | δ 8.08 (dd, 2H), 8.03 (dd, 2H), 7.53 (tt, 1H), 7.50 (tt, 1H), 7.38 (t, 2H), 7.34 (t, 2H), 7.21 (d, 1H), 7.19 (d, 1H), 2.28 (s, 3H), 1.34 (s, 9H). |
| 3,5-diisopropyl-1,2-phenylene dibenzoate (IED3) | 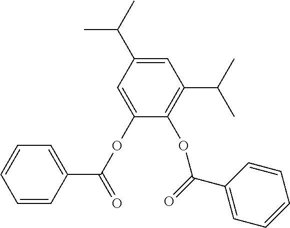 [SMILES: CC(C)c1cc(OC(=O)c2ccccc2)c(OC(=O)c2ccccc2)c(C(C)C)c1] | δ 8.08 (dd, 2H), 7.00 (dd, 2H), 7.53 (tt, 1H), 7.48 (tt, 1H), 7.39 (t, 2H), 7.31 (t, 2H), 7.11 (d, 1H), 7.09 (d, 1H), 3.11 (heptat, 1H), 2.96 (heptat, 1H), 1.30 (d, 6H), 1.26 (d, 6H). |
| 3,6-dimethyl-1,2-phenylene dibenzoate (IED4) | 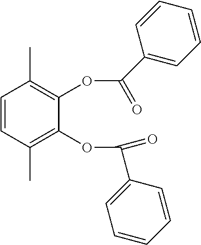 [SMILES: Cc1ccc(C)c(OC(=O)c2ccccc2)c1OC(=O)c1ccccc1] | δ 8.08 (d, 2H), 7.51 (t, 1H), 7.34 (d, 2H), 7.11 (s, 2H), 2.23 (s, 6H). |
| 4-t-butyl-1,2-phenylene dibenzoate (IED5) | 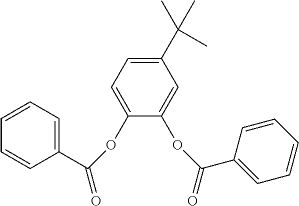 [SMILES: CC(C)(C)c1ccc(OC(=O)c2ccccc2)c(OC(=O)c2ccccc2)c1] | δ 8.07 (dd, 4H), 7.54 (m, 2H), 7.30-7.40 (m, 7H), 1.37 (s, 9H). |
| 4-methyl 1,2-phenylene dibenzoate (IED6) | 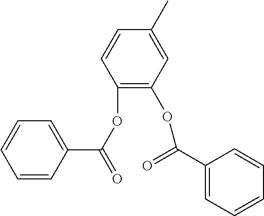 [SMILES: Cc1ccc(OC(=O)c2ccccc2)c(OC(=O)c2ccccc2)c1] | δ (ppm) 8.07 (d, 4H), 7.54 (t, 2H), 7.37 (t, 4H), 7.27 (d, 1H), 7.21 (s, 1H), 7.15 (d, 1H), 2.42 (s, 3H). |
| 1,2-naphthalene dibenzoate (IED7) | 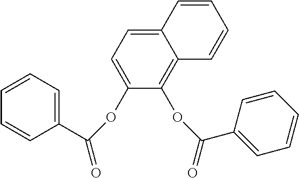 [SMILES: O=C(Oc1ccc2ccccc2c1OC(=O)c1ccccc1)c1ccccc1] | δ 8.21-8.24 (m, 2H), 8.08- 8.12 (m, 2H), 7.90-7.96 (m, 2H), 7.86 (d, 1H), 7.60 (m, 1H), 7.50-7.55 (m, 4H), 7.46 (t, 2H), 7.37 (t, 2H). |
| 2,3-naphthalene dibenzoate (IED8) | 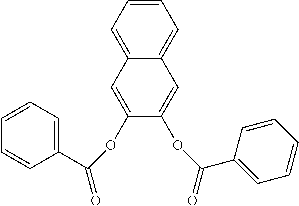 [SMILES: O=C(Oc1cc2ccccc2cc1OC(=O)c1ccccc1)c1ccccc1] | δ 8.08-8.12 (m, 4H), 7.86- 7.90 (m, 4H), 7.51-7.58 (m, 4H), 7.38 (t, 4H) |
| 3-methyl-5-tert-butyl-1,2-phenylene di(4-methylbenzoate) (IED9) | 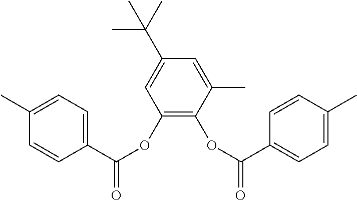 | δ (ppm) 7.98 (d, 2H), 7.93 (d, 2H), 7.18 (d, 4H), 7.15 (d, 2H), 2.38 (s, 3H), 2.36 (s, 3H), 2.26 (s, 3H), 1.35 (s, 9H). |
| 3-methyl-5-tert-butyl-1,2-phenylene di(2,4,6-trimethylbenzoate) (IED10) | 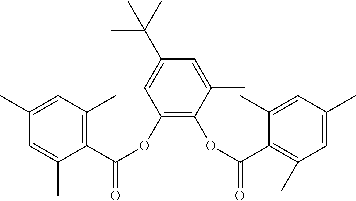 | δ (ppm) 7.25 (s, 1H), 7.21 (s, 1H), 6.81 (d, 4H), 2.36 (s, 3H), 2.30 (d, 6H), 2.25 (s, 6H), 2.23 (s, 6H), 1.36 (s, 9H). |
| 3-methyl-5-tert-butyl-1,2-phenylene di(4-fluorobenzoate) (IED11) | 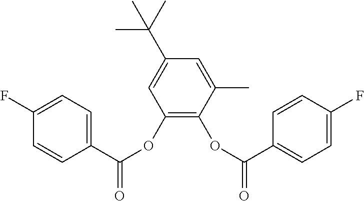 [SMILES: Cc1cc(C(C)(C)C)cc(OC(=O)c2ccc(F)cc2)c1OC(=O)c1ccc(F)cc1] | δ 7.98 (dd, 4H), 7.36 (dd, 4H), 7.21 (s, 1H), 7.17 (s, 1H), 2.26 (s, 3H), 1.34 (s, 9H). |
| 3-methyl-5-tert-butyl-1,2-phenylene di(4-chlorobenzoate) (IED12) | 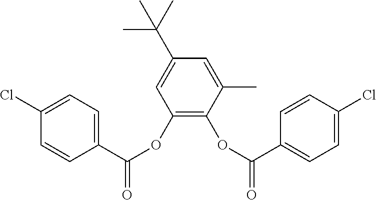 [SMILES: Cc1cc(C(C)(C)C)cc(OC(=O)c2ccc(Cl)cc2)c1OC(=O)c1ccc(Cl)cc1] | Δ 7.98 (dd, 4H), 7.36 (dd, 4H), 7.21 (s, 1H), 7.17 (s, 1H), 2.26 (s, 3H), 1.34 (s, 9H). |

### Examples 1-6

### Procatalyst

Examples 1-6 are made with a SPAD-containing Ziegler-Natta procatalyst composition composed of titanium, magnesium, and an internal electron donor of 3-methyl-5-tert-butyl-1,2-phenylene dibenzoate.

Comparative Sample 1 (CS1) Procatalyst

CS1 is made with SHAC™ 310, a Ziegler-Natta procatalyst composition composed of titanium magnesium and an internal electron donor of di-isobutylphthalate.

### 2. Polymerization

Polymerization is performed in liquid propylene in a 1-gallon autoclave using separate injection. The external electron donor is n-propyltrimethoxysilane (NPTMS) and isopropyl myristate. After conditioning, the reactor is charged with 1375 g of propylene (examples 5-6 utilize propylene and ethylene) and a desired amount of hydrogen and brought to 62° C. External electron donor, a solution of 0.27-M triethylaluminum in iso-octane, and a suitable amount of 5.0-wt % catalyst slurry in mineral oil (as indicated in data tables below) are premixed in the same vial for 20 minutes at room temperature and then charged into the reactor followed by isooctane flushing using a high pressure catalyst injection pump to initiate the polymerization. After the exotherm, the temperature is controlled to 67° C. Run time is 1 hour.

Examples 1-4 are wash-free propylene homopolymer made with the SPAD-containing Ziegler-Natta procatalyst composition. Examples 5-6 are wash-free propylene/ethylene copolymer made with the SPAD-containing procatalyst composition.

CS1 is unwashed propylene homopolymer made with SHAC™ 301 procatalyst composition.

CS2 is a washed propylene homopolymer sold under the tradename Borclean HC318BF, available from Borealis.

Examples 1-6 and CS1-2 are formed into a biaxially oriented film with a thickness of 6-8 microns. The films are produced by a lab stretcher at 155° C. with bi-axial stretching.

All of the examples and the comparative samples have the same additive package consisting of 600 ppm of Irganox 1010, 1200 ppm of Irgafos 168, and 250 ppm of DHT-4A.

X-ray analysis is used to determine the total ash in the examples.

TABLE 3

| | CS1 | CS2* | E1 | E2 | E3 | E4 | E5 | E6 |
|---|---|---|---|---|---|---|---|---|
| Propylene- | homo- | homo- | homo- | homo- | homo- | homo- | Random | Random |
| based | polymer | polymer | polymer | polymer | polymer | polymer | copolymer | copolymer |
| polymer | | | | | | | | |
| Total Ash | 202 | 20 | 23 | 21 | 38 | 39 | 26 | 32 |
| Content | | | | | | | | |
| XS | 5.9 | 4.0 | 5.8 | 5.2 | 3.2 | 2.6 | 3.8 | 4.2 |
| (wt %) | | | | | | | | |
| MFR | 3.6 | 3.2 | 3.1 | 2.6 | 3.0 | 3.1 | 3.5 | 3.7 |
| (g/10 min) | | | | | | | | |
| Et | — | — | — | — | — | — | 0.7 | 0.9 |
| (wt %) | | | | | | | | |
| Dielectric | 614 | 545 | | 712 | | | 646 | |
| Strength | | | | | | | | |
| (KV/mm) | | | | | | | | |

*CS2 is Borealis Borclean HC318BF, washed

Table 3 demonstrates that wash-free Examples 1-6 have significantly lower total ash as compared to the unwashed CS1.

Wash-free Examples 1-6 have comparable total ash content as compared to CS2, a washed propylene homopolymer.

Lower xylene solubles in the polymer tends to result in higher total ash content. Unexpectedly, Examples 3 and 4 have low xylene solubles content (less than 4.0 wt %) and still exhibit only 20% of the total ash content found in CS1.

Surprisingly, the examples, E2 and E5, have higher dielectric strength than either CSI and/or CS2. At similar total ash content, the examples, E2 and E5 are wash-free and unexpectedly have greater dielectric strength than CS2, a washed propylene homopolymer.

It is specifically intended that the present disclosure not be limited to the embodiments and illustrations contained herein, but include modified forms of those embodiments including portions of the embodiments and combinations of elements of different embodiments as come within the scope of the following claims.

What is claimed is:

1. A process comprising:
contacting, under polymerization conditions, propylene and optionally one or more comonomers with a catalyst composition comprising a substituted phenylene aromatic diester; and
forming a wash-free propylene-based polymer with a total ash content less than 30 ppm.

2. The process of claim 1 comprising forming a wash-free propylene-based polymer with a property selected from the group consisting of from 0 ppm to 10 ppm aluminum, from 0 ppm to 10 ppm chlorine, from 0 ppm to 10 ppm magnesium, from 0 ppm to 10 ppm titanium, and combinations thereof.

3. The process of claim 1 comprising forming a propylene-based polymer having less than 6.0 wt % xylene solubles content.

4. The process of claim 1 comprising contacting propylene with a catalyst composition comprising a substituted phenylene aromatic diester that is 3-methyl-5-tert-butyl-1,2-phenylene dibenzoate; and forming a propylene homopolymer.

5. The process of claim 1 comprising contacting propylene and ethylene with a catalyst composition comprising a substituted phenylene aromatic diester that is 3-methyl-5-tert-butyl-1,2-phenylene dibenzoate and forming a propylene/ethylene copolymer.

6. The process of claim 1 comprising biaxially orienting the propylene-based polymer; and forming a film having a thickness from 2 microns to 20 microns.

7. The process of claim 1 comprising forming a film having a thickness from 2 microns to 20 microns and a dielectric strength from 620 KV/mm to 720 KV/mm as measured in accordance with DIN IEC 243-2.

8. The process of claim 1 comprising coating an electrical component with the wash-free propylene-based polymer.

9. The process of claim 1 comprising coating, with the wash-free propylene-based polymer, an electrical component selected from the group consisting of a transformer, a capacitor, a switch, a regulator, a circuit breaker, a recloser, a fluid-filled transmission line, and combinations thereof.

10. The process of claim 1 comprising forming a film on an electrical component, the film comprising the wash-free propylene-based polymer.

11. The process of claim 1 comprising forming a film having a thickness from 2 microns to 20 microns on a capacitor, the film comprising the wash-free propylene-based polymer and having a total ash content less than 30 ppm.
